(19) United States
(12) Patent Application Publication
(10) Pub. No.: US 2021/0214528 A1
(43) Pub. Date: Jul. 15, 2021

(54) A REINFORCED POLYMERIC MATERIAL AND A METHOD OF MANUFACTURING A REINFORCED POLYMERIC MATERIAL

(71) Applicant: PETROLIAM NASIONAL BERHAD, Kuala Lumpur (MY)

(72) Inventors: Wei Siang SUM, Kuala Lumpur (MY); Yin Liong LEONG, Kuala Lumpur (MY); Kok Hoong LEONG, Kuala Lumpur (MY); Shamsul Farid Samsudin MOHD, Kuala Lumpur (MY)

(21) Appl. No.: 17/272,883

(22) PCT Filed: Aug. 30, 2019
(86) PCT No.: PCT/MY2019/050050

§ 371 Date: Mar. 2, 2021

(30) Foreign Application Priority Data
Sep. 3, 2018 (MY) PI 2018001522

(51) Int. Cl. C08K 7/06; C08K 3/04

(52) U.S. Cl. CPC C08K 7/06; C08K 3/04

(57) ABSTRACT

Disclosed herein is a reinforced polymeric material, where a polymeric matrix material is filled with a 2-dimensional material that has an average aspect ratio of from 100 to 2000 and a fibrous reinforcing material. The composition may optionally also include a curing agent when needed. The material may be useful in providing a moulded material with improved deformation properties.

### FIELD OF INVENTION

This invention relates to an improved reinforced polymeric material and a method of manufacturing the like and its use in the formation of composite components, such as composite components requiring precision surfaces.

### BACKGROUND

The listing or discussion of a prior-published document in this specification should not necessarily be taken as an acknowledgement that the document is part of the state of the art or is common general knowledge.

Reinforced polymeric materials are frequently used to manufacture various composite components. Reinforced polymeric materials are “pre-impregnated” composite fibers where a thermoset or thermoplastic polymer matrix material, such as epoxy or polyamide, is already present. These composite fibers are normally provided in the form of a weave, non-woven, chop strand mat, where the polymer matrix material is used to bond the fibers together and (where necessary) to other components during manufacture of the final product.

Unfortunately, while the use of reinforced polymeric materials would appear to be a very convenient way to manufacture composite components (e.g. control surfaces), the cured material tends to suffer from distortion and deformation. This is an issue for proper assembly or joining of components.

In order to overcome the above problems, current processes follow an essentially iterative process of making a desired mould, then forming the desired product and testing it for the above issues. Where the tested product suffers from the deformations above, modifications are made to the mould and/or the process and the cycle repeated. This process itself may take many cycles until something that resembles a useable product having the desired cured dimensions is obtained. However, this iterative process is extremely time-consuming and, in several cases, compromises on the material lay-up are also required so as to accommodate the deformation. As a result, the full potential of the composite material will not be realised. It would therefore be desirable to provide a reinforced polymeric material which overcomes or alleviates the above problems.

### SUMMARY OF INVENTION

It has been surprisingly found that the addition of 2-dimensional materials to a polymeric matrix results in the reduction of deformation of such materials. For example in moulded products made from such materials. Thus in a first aspect of the invention, there is provided a reinforced polymeric material comprising:
from 0.002 to 6 vol % of the composition of a 2-dimensional material in a filled polymeric matrix material, having an average aspect ratio of from 100 to 2000;
from 20 to 75 vol % of the composition of a fibrous reinforcing material in a filled polymeric matrix material; and
the balance being composed of the filled polymeric matrix material and, optionally, a curing agent.

In embodiments of the first aspect of invention:

(a) the filled polymeric matrix material may be a thermoset material (e.g. selected from one or more of the group consisting of an epoxy resin, a polyester, and a vinyl ester; optionally the epoxy resin may be selected bisphenol-A diglycidyl ether resin);

(b) the filled polymeric matrix material may be a thermoplastic material (e.g. the filled polymeric matrix material may be selected from one or more of the group consisting of a polyethylene, a polypropylene, a polyamide, and a polyether ether ketone; optionally the thermoplastic may be selected from one or more of the group consisting of high density polyethylene, medium density polyethylene and low density polyethylene);

(c) the 2-dimensional material may be selected from one or more of the group consisting of graphene, graphene oxide, reduced graphene oxide, graphene nanoplatelet, graphene having from 1 to 5 layers (e.g. from 1 to 3, such as bilayer graphene), hexagonal boron nitride (hBN), molybdenum disulphide (MoS₂), tungsten diselenide (WSe₂), silicone and germanene, including layered assemblies of mixtures of these materials (ISO/TS 80004-13), for example, the 2-dimensional material may be selected from one or more of the group consisting of graphene, chemically modified graphene, reduced graphene oxide, and boron nitride, and optionally wherein the 2-dimensional material is graphene;

(d) the 2-dimensional material may have an average aspect ratio of from 180 to 500;

(e) the reinforced polymeric material may comprise 0.05 vol % to 1 vol % of the composition of the 2-dimensional material in the polymeric matrix;

(f) the fibrous reinforcing material may be selected from one or more of the group consisting of glass, carbon fibre, Kevlar and engineering reinforcing fibres (e.g. the fibrous reinforcing material may be carbon fibre);

(g) the reinforced polymeric material may comprise from 50 vol % to 70 vol % of the composition of a fibrous reinforcing material;

(h) the curing agent may be selected from one or more of the group consisting of polyamines, aminoamides and phenolic compounds.

In a second aspect of the invention, there is provided a method of forming a moulded product from a reinforced polymeric material as defined in the first aspect of the invention and any technically sensible combination of its embodiments, wherein the process comprises the steps of:
(a) providing a reinforced polymeric material as defined in the first aspect of the invention and any technically sensible combination of its embodiments and laying up the material in a mould; and
(b) subjecting the reinforced polymeric material in the mould to curing to form a moulded product.

In a third aspect of the invention, there is provided a prepreg material formed from a reinforced polymeric material as defined in the first aspect of the invention and any technically sensible combination of its embodiments.

In a fourth aspect of the invention, there is provided a moulded product formed from a reinforced polymeric material as defined in the first aspect of the invention and any technically sensible combination of its embodiments and/or a prepreg material as defined in the third aspect of the invention. In embodiments of this aspect, the resulting moulded article may display a reduction in deformation compared to a moulded article formed from an otherwise identical reinforced polymeric material that does not contain the 2-dimensional material of from 20 to 100%, such as from 45 to 99%, such as from 46 to 90%.

Further aspects and embodiments of the invention are described in the following clauses.

1. A reinforced polymeric material comprising:
from 0.002 to 6 vol % of the composition of a 2-dimensional material in a filled polymeric matrix material, having an average aspect ratio of from 100 to 2000;
from 20 to 75 vol % of the composition of a fibrous reinforcing material in a filled polymeric matrix material; and

the balance being composed of the filled polymeric matrix material and, optionally, a curing agent.

2. The reinforced polymeric material according to Clause 1, wherein the filled polymeric matrix material is a thermoset material.

3. The reinforced polymeric material according to Clause 2, wherein the thermoset material is selected from one or more of the group consisting of an epoxy resin, polyester, and vinyl ester.

4. The reinforced polymeric material according to Clause 3, wherein the epoxy resin is bisphenol-A diglycidyl ether resin.

5. The reinforced polymeric material according to Clause 1, wherein the filled polymeric matrix material is a thermoplastic material.

6. The reinforced polymeric material according to Clause 5, wherein the thermoplastic material is selected from one or more of the group consisting of a polyethylene, a polypropylene, a polyamide, and a polyether ether ketone.

7. The reinforced polymeric material according to Clause 6, wherein the thermoplastic is selected from one or more of the group consisting of high density polyethylene, medium density polyethylene and low density polyethylene.

8. The reinforced polymeric material according to any one of the preceding clauses, wherein the 2-dimensional material is selected from one or more of the group consisting of graphene, graphene oxide, reduced graphene oxide, graphene nanoplatelet, graphene having from 1 to 5 layers (e.g. from 1 to 3 layers, such as bilayer graphene), hexagonal boron nitride (hBN), molybdenum disulphide (MoS₂), tungsten diselenide (WSe₂), silicone and germanene, including layered assemblies of mixtures of these materials (ISO/TS 80004-13).

9. The reinforced polymeric material according to Clause 8, wherein the 2-dimensional material is selected from one or more of the group consisting of graphene, chemically modified graphene, reduced graphene oxide, and boron nitride, optionally wherein the 2-dimensional material is graphene.

10. The reinforced polymeric material according to any one of the preceding clauses, wherein the 2-dimensional material has an average aspect ratio of from 180 to 500.

11. The reinforced polymeric material according to any one of the preceding clauses, wherein the reinforced polymeric material comprises 0.05 vol % to 1 vol % of the composition of the 2-dimensional material in the polymeric matrix.

12. The reinforced polymeric material according to any one of the preceding clauses, wherein the fibrous reinforcing material is selected from one or more of the group consisting of glass, carbon fibre, Kevlar and engineering reinforcing fibres.

13. The reinforced polymeric material according to Clause 12, wherein the fibrous reinforcing material is carbon fibre.

14. The reinforced polymeric material according to any one of the preceding clauses, wherein the reinforced polymeric material comprises from 50 vol % to 70 vol % of the composition of a fibrous reinforcing material.

15. The reinforced polymeric material according to any one of the preceding clauses, wherein the curing agent is selected from one or more of the group consisting of polyamines, aminoamides and phenolic compounds.

16. A method of forming a moulded product from a reinforced polymeric material as defined in any one of Clauses 1 to 15, wherein the process comprises the steps of:
(a) providing a reinforced polymeric material as defined in any one of Clauses 1 to 15 and laying up the material in a mould; and
(b) subjecting the reinforced polymeric material in the mould to curing to form a moulded product.

17. A prepreg material formed from a reinforced polymeric material as defined in any one of Clauses 1 to 15.

18. A moulded product formed from a reinforced polymeric material as defined in any one of Clauses 1 to 15 and/or a prepreg material as defined in Clause 17.

19. The moulded product according to Clause 18, wherein the resulting moulded product displays a reduction in deformation compared to a moulded product formed from an otherwise identical reinforced polymeric material that does not contain the 2-dimensional material of from 20 to 100%, such as from 45 to 99%, such as from 46 to 90%.

### DESCRIPTION

The current disclosure provides a material that overcomes some or all of the problems mentioned hereinbefore. Thus, there is disclosed a reinforced polymeric material comprising:
from 0.002 to 6 vol % of the composition of a 2-dimensional material in a filled polymeric matrix material, having an average aspect ratio of from 100 to 2000;
from 20 to 75 vol % of the composition of a fibrous reinforcing material in a filled polymeric matrix material; and
the balance being composed of the filled polymeric matrix material and, optionally, a curing agent.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

When used herein, “average aspect ratio” refers to the average lateral dimension of the material divided by the average thickness of the material. This ratio is applied to a 2-dimensional material, which is generally considered to be a material that is only one atom thick. However, when used herein this term is intended to cover materials that may be a few layers of atoms thick (e.g. from 1 to 5 layers thick, such as from 1 to 3, such as from 1 to 2 layers thick). Any suitable 2-dimensional material that is capable of reducing deformation may be used to form the reinforced polymeric materials discussed herein, provided that it is chemically compatible with the other components. Suitable 2-dimensional materials that may be mentioned herein include, but are not limited to, graphene, graphene oxide, reduced graphene oxide, graphene nanoplatelet, graphene having from 1 to 5 layers (e.g. from 1 to 3 layers, such as bilayer graphene), hexagonal boron nitride (hBN), molybdenum disulphide (MoS₂), tungsten diselenide (WSe₂), silicone and germanene, including layered assemblies of mixtures of these materials (ISO/TS 80004-13). In particular examples that may be mentioned herein, the 2-dimensional material may be selected from one or more of the group consisting of graphene, chemically modified graphene, reduced graphene oxide, and boron nitride. For example, the 2-dimensional material may be graphene.

As noted above, the 2-dimensional material may have an average aspect ratio of from 100 to 2000. In particular embodiments that may be mentioned herein, the 2-dimensional material may have an average aspect ratio of from 180 to 500, such as from 150 to 750 and the like. For the avoidance of doubt, it is specifically intended that the lower and upper values provided in a list of numerical ranges in respect of any numerical value may be combined in any way. For example, the 2-dimensional material disclosed herein may have the following numerical range values: from 100 to 2000, from 180 to 500, from 150 to 750, from 100 to 180, from 100 to 500, from 100 to 750, from 180 to 750, from 180 to 2000, from 500 to 750, from 500 to 2000, and from 750 to 2000.

As noted above, the 2-dimensional material may comprise from 0.002 to 6 vol % of the composition. In particular examples, the 2-dimensional material may comprise from 0.05 to 1 vol % of the composition, such as from 0.1 to 0.5 vol % of the composition. When used herein, the vol % of the composition refers to the entire volume of the composition once formed.

When used herein, the term “filled polymeric matrix material” is intended to refer to a polymeric material that encapsulated the other components (and so is filled by them). Any suitable polymeric material may be used. For example, the polymeric material may be a thermoplastic material or a thermoset material.

Examples of thermoset materials that may be mentioned herein include, but are not limited to an epoxy resin, a polyester, a vinyl ester, and combinations thereof. In particular embodiments that may be mentioned herein, the thermoset material may be the epoxy resin bisphenol-A diglycidyl ether resin.

Examples of thermoplastic materials that may be mentioned herein include, but are not limited to a polyethylene, a polypropylene, a polyamide, a polyether ether ketone, and combinations thereof. For example, the thermoplastic material may be selected from one or more of high density polyethylene, medium density polyethylene, and low density polyethylene.

As will be appreciated, when there is more than one polymeric material used, the resulting polymeric matrix is a blend of the chosen polymeric materials. This may be used when particular properties are required. It is contemplated that in some embodiments, the polymeric material may be a blend comprising both thermoplastic and thermoset materials.

Any suitable fibrous reinforcing material may be used herein. For example, the fibrous reinforcing material may be selected from the group including, but not limited to glass, carbon fibre, Kevlar, engineering reinforcing fibres and combinations thereof. In particular embodiments that may be mentioned herein, the fibrous reinforcing material may be carbon fibre.

As noted above, the fibrous reinforcing material may be present in an amount of from 20 to 75 vol % of the composition. Examples of other suitable ranges for the fibrous reinforcing material in the composition include from 25 to 72 vol % and from 50 to 70 vol % of the composition.

In certain embodiments of the composition, the reinforced polymeric material may contain a curing agent. When used herein “curing agent” refers to a material that may form cross-links between the polymer chains of the polymeric material. Any suitable curing agent may be used herein—provided that it is compatible with at least one of the polymeric materials that form the filled polymeric matric material. Examples of suitable crosslinking agents that may be mentioned include, but are not limited to polyamines, aminoamides, phenolic compounds and combinations thereof. As will be appreciated by the skilled person, the amount of crosslinking agent required in the composition (when present) can be readily determined by the skilled person based on the polymeric material(s) used and the desired properties of the subsequently cured material.

The reinforced polymeric materials disclosed herein may be formed by any suitable method. For example, a 2-dimensional material (also described herein as a filler material) may be dispersed within a suitable solvent (e.g. isopropanol) at a suitable concentration (e.g. from 0.01 to 1 g/mL of solvent, such as 0.05 g/mL of solvent) followed by sonication for a suitable period of time (e.g. 30 minutes at 37 kHz). The resulting suspension may then be blended with the polymeric matrix material and vented to remove the solvent (e.g. 250 g resin to 0.5 g 2-dimensional material). The fibre reinforcing material may then combined with the composition in the necessary amount to provide the desired reinforcement (determinable by a skilled person based on the desired use; and determined in vol %) using any suitable method to do so (e.g. mechanical impregnation equipment). If a curing agent (or hardener) is to be added to the composition, this may be added before combining with the fibre reinforcing material. An example of the above procedure is provided in the examples section hereinbelow. Such materials (before curing and/or hardening) may be described as a prepreg material. Thus, the current invention also relates to the formation of prepreg materials and prepreg materials per se, which materials are essentially a reinforced polymeric material as described herein above.

The reinforced polymeric material disclosed herein may be used to form a polymeric product. An advantage associated with the moulded product made using the reinforced polymeric materials described herein is that it displays a reduction in deformation compared to a moulded product formed from an otherwise identical reinforced polymeric material that does not contain the 2-dimensional material. Said reduction in deformation may be from 20 to 100%, such as from 45 to 99%, such as from 46 to 90%.

The moulded products described herein may be formed from the reinforced polymeric materials described above, by a process that comprises the steps of:
(a) providing a reinforced polymeric material as defined above and laying up the material in a mould; and
(b) subjecting the reinforced polymeric material in the mould to curing to form a moulded product.

Further aspects and embodiments of the invention are described hereinbelow in the

### EXAMPLES

### Example 1

### Preparation of Reinforced Polymeric Material

A 2-dimensional filler material, such as graphene, was first blended with a Bisphenol-A diglycidyl ether (BADGE) resin at approximately 0.10 vol % relative to the resin.

To prepare the 2-dimensional filler material for blending, isopropanol was first mixed with the 2-dimensional filler material at a concentration of about 0.05 g filler/1 ml isopropanol. The mixture was then sonicated at a frequency of 37 kHz for at least 30 minutes. After the preparation step, the mixture of filler and solvent was blended with Bisphenol-A diglycidyl ether (BADGE) resin, while venting at room temperature for more than 8 hours to form a blended resin. The amount of resin used was 250 g with 0.5 g of graphene.

The blended resin was then mixed with 87.5 g of an amine hardener, and pre-impregnated into fibre reinforcements, such as 0/90 NCF (656 gsm) carbon fibre (approximately 0.8-0.9 mm thick), with the aid of an in-house mechanical impregnation equipment so as to produce a reinforced polymeric material as a prepreg. The impregnation equipment consists of a resin bath in which the “dry” fibre reinforcement fabric from one end, was drawn into and subsequently wound together on a pickup roller as a prepreg. The speed of impregnation was controlled at about 4 revolutions per minute of the pickup roller. The overall composition has a fibre reinforcements content of approximately 60 vol %, 0.10 vol % graphene, with the balance being composed of the polymeric matrix material and curing agent.

### Manufacturing of a L-Bracket Component for Testing and Analysis

To measure the degree of deformation experienced by the resultant cured reinforced polymeric material, an L-bracket component was manufactured using the prepreg reinforced polymeric material, and the internal angle of the bend was measured.

Four layers of the prepreg reinforced polymeric material were first cut and stacked onto a right-angled mould with a 3 mm radius. The mould and stacked layers were then vacuum bagged and cured at a temperature of 80° C. under vacuum for at least 6 hours. After curing, the stacked reinforced polymeric layers were de-moulded to provide the L-bracket component. The L-brackets had an approximate length of 70 mm on both sides with width of approximately 35 mm, and internal radius of 3 mm.

As controls, L-bracket components made from reinforced neat prepreg resins (without the addition of any filler material) were also manufactured with the above method.

The difference in deformation between the two sets of L-bracket components upon full cure and de-moulding were compared by measuring the angles of the L-brackets using a bevel protractor.

Overall, as compared to the neat reinforced resins (i.e. resins with no filler material), the L-brackets formed by the impregnated resin of the present invention show an increased resistance to deformation. Specifically, the L-bracket components manufactured from the reinforced polymeric material of the present invention exhibits up to 46% reduction in deformation from 0.217° deformation (neat) to about 0.1° deformation (filled).

### Example 2

To prepare a thermoplastic matrix with 2-dimensional filler material like graphene, approximately 0.5 weight % of graphene is mixed with HDPE, for example 45 g graphene and 8955 g HDPE are mixed together for a total 9 kg. The HDPE is in the form of pellets or powder or a combination of pellets and powder. Mixing is done on a shaker with the materials sealed within a bag. The mixed material is then fed into an extruder with screw speed of about 600 rpm and die temperature 180C-220C. The extruded material is chopped into pellets to form the “filled pellets”. The extrusion may be repeated to improve dispersion of fillers within the pellets.

The filled pellets can be used to make thermoplastic fibre-reinforced components, for example in injection moulding or extrusion processes, where fibre reinforcements are added during the manufacturing process.

Like the thermoset example (Example 1), the presence of 2-dimensional fillers can reduce the deformation of manufactured components compared to the unfilled components.

1. A reinforced polymeric material comprising:
from 0.002 to 6 vol % of the composition of a 2-dimensional material in a filled polymeric matrix material, having an average aspect ratio of from 100 to 2000;
from 20 to 75 vol % of the composition of a fibrous reinforcing material in a filled polymeric matrix material; and
the balance being composed of the filled polymeric matrix material and, optionally, a curing agent.

2. The reinforced polymeric material according to claim 1, wherein the filled polymeric matrix material is a thermoset material.

3. The reinforced polymeric material according to claim 2, wherein the thermoset material is selected from one or more of the group consisting of an epoxy resin, polyester, and vinyl ester.

4. The reinforced polymeric material according to claim 3, wherein the epoxy resin is bisphenol-A diglycidyl ether resin.

5. The reinforced polymeric material according to claim 1, wherein the filled polymeric matrix material is a thermoplastic material.

6. The reinforced polymeric material according to claim 5, wherein the thermoplastic material is selected from one or more of the group consisting of a polyethylene, a polypropylene, a polyamide, and a polyether ether ketone.

7. The reinforced polymeric material according to claim 6, wherein the thermoplastic is selected from one or more of the group consisting of high density polyethylene, medium density polyethylene and low density polyethylene.

8. The reinforced polymeric material according to claim 1, wherein the 2-dimensional material is selected from one or more of the group consisting of graphene, graphene oxide, reduced graphene oxide, graphene nanoplatelet, graphene having from 1 to 5 layers, hexagonal boron nitride (hBN), molybdenum disulphide (MoS₂), tungsten diselenide (WSe₂), silicone and germanene, including layered assemblies of mixtures of these materials (ISO/TS 80004-13).

9. The reinforced polymeric material according to claim 8, wherein the 2-dimensional material is selected from one or more of the group consisting of graphene, chemically modified graphene, reduced graphene oxide, and boron nitride.

10. The reinforced polymeric material according to claim 1, wherein the 2-dimensional material has an average aspect ratio of from 180 to 500.

11. The reinforced polymeric material according to claim 1, wherein the reinforced polymeric material comprises 0.05 vol % to 1 vol % of the composition of the 2-dimensional material in the polymeric matrix.

12. The reinforced polymeric material according to claim 1, wherein the fibrous reinforcing material is selected from one or more of the group consisting of glass, carbon fibre, Kevlar and engineering reinforcing fibres.

13. The reinforced polymeric material according to claim 12, wherein the fibrous reinforcing material is carbon fibre.

14. The reinforced polymeric material according to claim 1, wherein the reinforced polymeric material comprises from 50 vol % to 70 vol % of the composition of a fibrous reinforcing material.

15. The reinforced polymeric material according to claim 1, wherein the curing agent is selected from one or more of the group consisting of polyamines, amino amide s and phenolic compounds.

16. A method of forming a moulded product, wherein the process comprises the steps of:
(a) providing a reinforced polymeric material as defined in claim 1 and laying up the material in a mould; and
(b) subjecting the reinforced polymeric material in the mould to curing to form a moulded product.

17. A prepreg material formed from a reinforced polymeric material as defined in claim 1.

18. A moulded product formed from a reinforced polymeric material as defined in claim 1.

19. A moulded product formed from a prepreg material as defined claim 17.

20. The moulded product according to claim 18, wherein the resulting moulded product displays a reduction in deformation compared to a moulded product formed from an otherwise identical reinforced polymeric material that does not contain the 2-dimensional material of from 20 to 100%.

21. (canceled)
